(19) United States
(12) Patent Application Publication
(10) Pub. No.: US 2010/0027514 A1
(43) Pub. Date: Feb. 4, 2010

(54) WIRELESS COMMUNICATION SYSTEM AND WIRELESS COMMUNICATION METHOD

(75) Inventor: TOMOFUMI HIGASHIDE, Kanagawa (JP)

Correspondence Address: YOUNG & THOMPSON, 209 Madison Street, Suite 500, Alexandria, VA, 22314, US

(73) Assignee: NEC Electronics Corporation, Kanagawa (JP)

(21) Appl. No.: 12/499,815

(22) Filed: Jul. 9, 2009

(30) Foreign Application Priority Data
Jul. 30, 2008 (JP) 2008-196570

(51) Int. Cl. H04B 7/212

(52) U.S. Cl. 370/337

(57) ABSTRACT

There is provided a wireless communication system capable of requesting activation from a host without reserving a time slot for performing data transfer. There is provided a wireless communication system provided with a host 1 and devices (2-1) to (2-n) which perform wireless communication with the host 1. The devices (2-1) to (2-n) transmit a remote activation notification requesting activation of the host 1 during a beacon period which is a period for reserving a time slot for performing data transfer. When receiving the remote activation notification from the devices (2-1) to (2-n), the host 1 returns from a sleep state to an active state.

### BACKGROUND OF THE INVENTION

1. Field of the Invention

The present invention relates to a wireless communication system and a wireless communication method, and in particular to a wireless communication system and a wireless communication method capable of switching a host apparatus from a sleep state to an active state by remote control.

2. Description of the Related Art

As an interface for connecting a personal computer and a peripheral device, a USB method utilizing a USB (Universal Serial Bus) has been put to practical use. In the USB method, the personal computer, which is a host computer, and the peripheral device are connected via a cable. Recently, there has been a demand for wirelessly implementing this connection, and a wireless USB method for performing USB connection by wireless communication has been put to practical use. A host computer in the wireless USB method is referred to as a wireless USB host, and a peripheral device connected to the host computer is referred to as a wireless USB device.

In the wireless USB method, it is possible to connect one or multiple wireless USB devices to one host, similarly to the USB method.

In the wireless USB method, communication is performed in accordance with separated time periods (time slots) to avoid conflicts among multiple communications. By synchronizing the local timers of the wireless USB devices with one another, transmission and receiving of data using the time slots are managed. Periodic time used in the wireless USB method is managed in units called superframes. One superframe is divided in sixteen sections, and one section is further divided in sixteen time units called media access slots (MAS's) and managed.

In the wireless USB method, the wireless USB device reserves, in advance, a media access slot (MAS) for performing communication before performing data transfer, and performs communication only during this determined time period. Such a communication method is called a distributed reservation protocol (DRP).

In the wireless USB method, a particular media access slot at the top of each superframe is used for transmission and receiving of a beacon. This period is referred to as a beacon period (BP), and data is transmitted in a media access slot different from the beacon period. Here, a beacon is control information for performing reservation of a media access slot for performing data transfer or synchronization of the local timers. The wireless USB host and the wireless USB devices include such control information elements (IE's) in a beacon and transmit the beacon.

The wireless USB host is able to transition to a sleep state during a period in which it does not have to operate, for the purpose of suppressing the operating power. The wireless USB devices are able to cause the wireless USB host which has transitioned to the sleep state to return to a normal operation state by remote control (hereinafter this is referred to as remote activation).

In the case where the wireless USB device notifies remote activation to the wireless USB host, the wireless USB device performs it by including a notification for notifying remote activation in a packet transmitted as transfer data. The technique for activating the wireless USB host in the sleep state by remote control is also disclosed, for examples in Japanese Patent Laid-Open No. 2007-214730, National Publication of International Patent Application No. 2007-524304 and Japanese Patent Laid-Open No. 2006-93787.

The case of notifying remote activation in a conventional wireless USB method will be described with reference to FIG. 4. The wireless USB host which has transitioned to the sleep state transmits a beacon 46 which includes DRP_IE using a beacon slot within a beacon period which is assigned to the wireless USB host itself. Here, DRP_IE is an information element for reserving a media access slot in which data transfer is to be performed. In addition to DRP_IE, the beacon 46 includes information such as a header including identification information about itself, a beacon parameter and an FCS (Frame Check Sequence) for performing error detection.

FIG. 4 shows an example in which the wireless USB host transmits the beacon 46 which includes DRP_IE, in a superframe (N−1), and the wireless USB transmits a device notification for remote activation notification 48 to the wireless USB host using a media access slot (MAS) of a superframe N reserved by the DRP_IE.

As described above, the wireless USB host performs reservation of a media access slot by transmitting the beacon 46 which includes DRP_IE within a beacon period. However, there is a possibility that a media access slot (MAS) cannot be reserved, for example, because the reservation conflicts with reservation by a different wireless USB device. In such a case, the wireless USB host newly performs reservation of a media access slot again.

When the reservation of a media access slot (MAS) is completed, the wireless USB host resumes a wireless USB channel. The wireless USB host sets a schedule for a device notification time slot (DNTS) indicating time for the wireless USB device to transmit a device notification, and transmits the set device notification time slot (DNTS) as control information (MMC: Micro-Scheduled Management Command) 47 in a media access slot 45 reserved by DRP.

The wireless USB device keeps looking for the control information (MMC) 47 transmitted from the wireless USB host during a superframe 42. The wireless USB device which has received the control information (MMC) 47 transmits the device notification for remote activation notification 48, which is a notification for activating the wireless USB host by remote control, in accordance with the device notification time slot (DNTS) notified by the wireless USB host.

When receiving the device notification for remote activation notification 48, the wireless USB host executes remote activation processing, and returns to the normal operation state from the sleep state. If the wireless USB host does not receive the device notification for remote activation notification 48 from the wireless USB device in the device notification time slot (DNTS) set by itself, the wireless USB host keeps the sleep state.

However, in the conventional wireless communication system as described above, the wireless USB host has to reserve a media access slot to be used, in advance, to transmit the control information (MMC). Therefore, if a media access slot cannot be reserved, the wireless USB device cannot transmit the remote activation notification before the next reservation period.

Furthermore, even if a media access slot can be reserved, the wireless USB device is required to receive the control information (MMC) transmitted from the wireless USB host. Therefore, the wireless USB device has to be active to keep a receiving state during a superframe period, and therefore, the operating power on the wireless USB device side cannot be reduced.

### SUMMARY

In an aspect of a wireless communication system according to the present invention, there are provided a host and a device which performs wireless communication with the host; and the aspect is characterized in that the device transmits a remote activation notification requesting activation of the host during a beacon period for sending out a beacon which includes reservation information for reserving a time slot for performing data transfer, and that, when receiving the remote activation notification from the device during the beacon period, the host switches the operation state from a sleep state to an active state.

As described above, by transmitting the remote activation notification requesting activation of the host during the beacon period, it is possible to notify a request to return to an active state, from a device to the host without performing reservation of data transfer. Thereby, the wireless USB device does not have to be active during the period of a superframe and realize power saving of the wireless USB device.

Furthermore, a wireless communication method according to the present invention is characterized in that a remote activation notification requesting activation of a host is transmitted during a beacon period for sending out a beacon which includes reservation information for reserving a time slot for performing data transfer.

As described above, by transmitting the remote activation notification requesting activation of the host during the beacon period, it is possible to activate the host without performing reservation of data transfer.

According to an aspect of the wireless communication system and wireless communication method according to the present invention, it is possible to transmit a command for switching from a sleep state to an active state by remote control, to a wireless USB host without performing reservation of a media access slot.

### BRIEF DESCRIPTION OF THE DRAWINGS

FIG. 1 shows the configuration of a wireless communication system to which a wireless communication method of the present invention is applied;

FIG. 2 shows the configuration of a superframe used in a wireless communication system according to an embodiment of the present invention;

FIG. 3 is a diagram for illustrating the operation of remote activation in wireless communication of the present invention; and

FIG. 4 is a diagram for illustrating the operation of remote activation in conventional wireless USB communication.

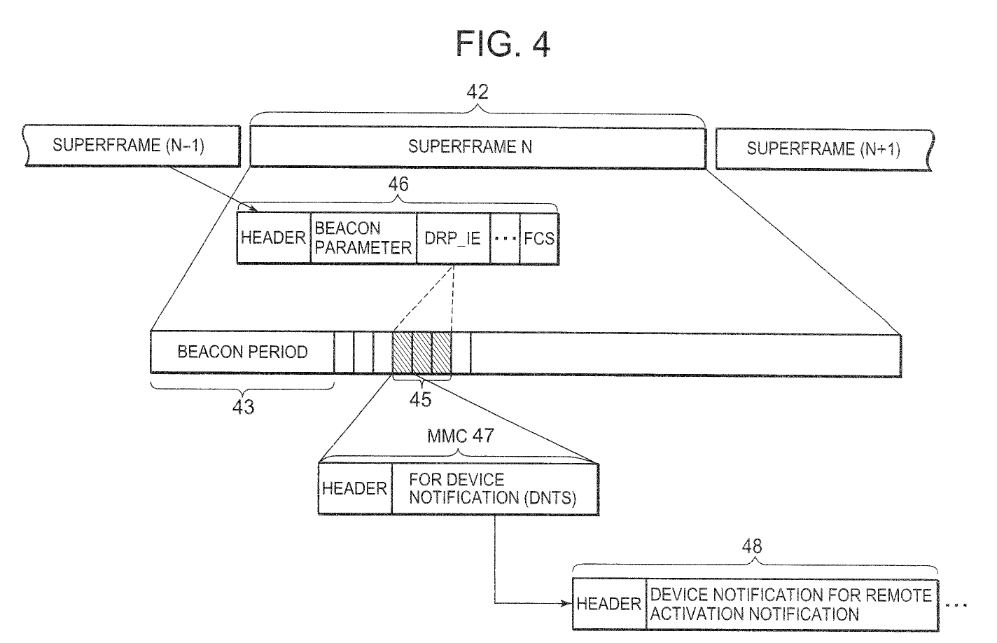

### DETAILED DESCRIPTION OF THE PREFERRED EMBODIMENTS

An embodiment of the present invention will be described with reference to accompanying drawings.

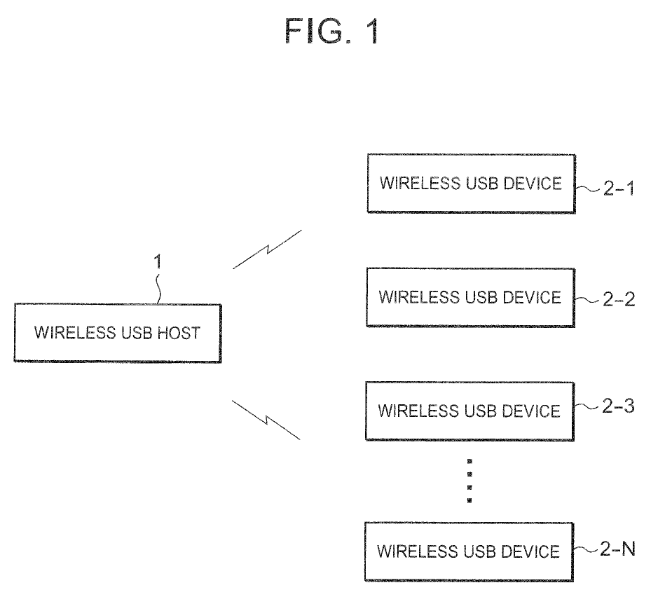

FIG. 1 is a block diagram showing the configuration of a wireless USB communication system according to the embodiment of the present invention. This communication system is provided with one wireless USB host 1 and n wireless USB devices 2. The wireless USB devices are denoted by (2-1) to (2-n) (n is an integer more than 1) to identify them, respectively.

The wireless USB host 1 and the wireless USB devices (2-1) to (2-n) are wirelessly connected so that they can transmit and receive data to and from one another. In order to implement the wireless USB of the embodiment of the present invention, for example, a MAC superframe structure based on the WiMedia standards or the MAC-PHY interface standard of WiMedia can be used

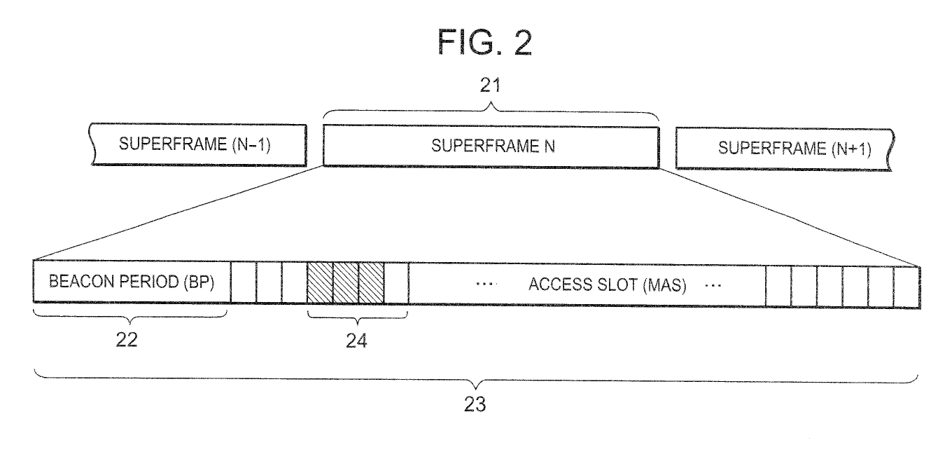

FIG. 2 is a diagram showing a configuration example the superframe structure. Periodic time used in the wireless USB method is managed in units called superframes. A superframe 21 is divided in multiple media access slots (MAS's) 23. Within the superframe 21, the top media access slot 23 is used to transmit a beacon. Among the media access slots 23, a period for transmitting and receiving a beacon is referred to as a beacon period (BP) 22. A beacon is an information packet for performing reservation of a media access slot for performing data transfer and exchange of control information with a different wireless USB device. To the media access slots 23 other than the beacon period 22, media access slots 24, which are schedule-managed by the wireless USB host in accordance with a distributed reservation protocol method, are assigned.

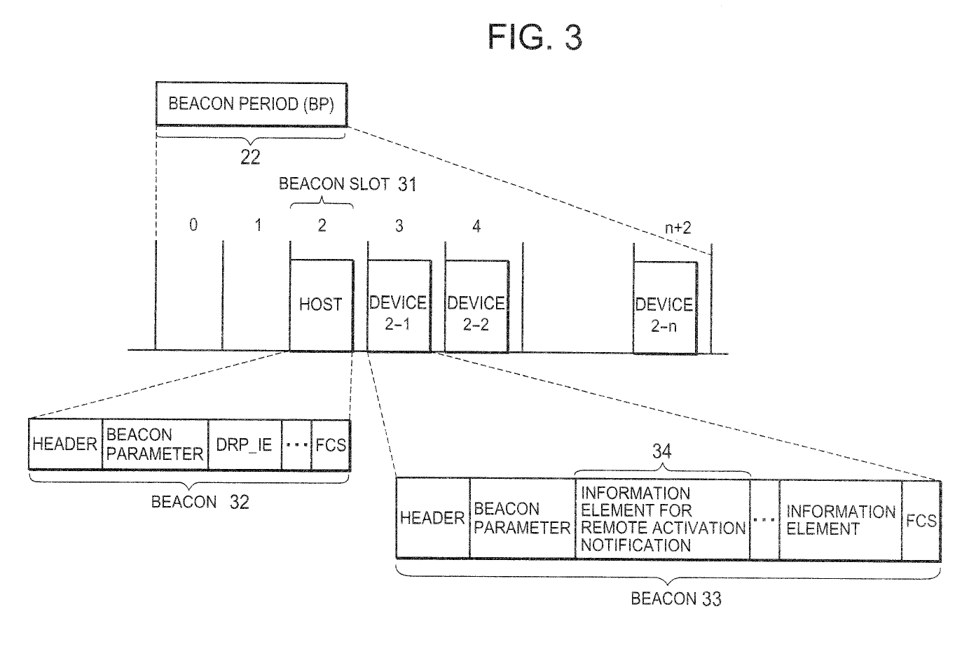

FIG. 3 is a diagram showing the configuration of the beacon period. The beacon period (BP) 22 is configured by multiple beacon slots 31. Slot number 0 to slot number (n+2) are given to the beacon slots 31, respectively. The beacon slots 31 for transmitting a beacon are assigned to the wireless USB host 1 and the USB wireless devices (2-1) to (2-n), respectively. Specifically, the beacon slot 31 of the slot number 2 is assigned to the wireless USB host 1, and the beacon slots 31 of the slot numbers 3 to (n+2) are assigned to the wireless USB devices (2-1) to (2-n), respectively. Each of the wireless USB host 1 and the wireless USB devices (2-1) to (2-n) transmits a beacon in its own beacon slot 31.

The beacon transmitted or received by the wireless USB host 1 and the wireless USB devices (2-1) to (2-n) is a special packet transmitted or received in a beacon period within a superframe. By including information elements in the beacon and transmitting it, information, for example, about reservation of a media access slot, the state of a wireless USB device existing nearby and the like is exchanged. By each of the wireless USB devices (2-1) to (2-n) finding an unused beacon slot 31, the beacon slot 31 is assigned to the wireless USB device. Specifically, each of the wireless USB devices (2-1) to (2-n) receives a beacon transmitted from the wireless USB host 1 or a different USB device among the wireless USB devices (2-1) to (2-n) and analyzes information included in the beacon. The beacon includes information indicating which of the wireless USB devices (2-1) to (2-n) occupies which beacon slot 31. By analyzing this information, each of the wireless USB devices (2-1) to (2-n) finds an unused beacon slot 31 and uses it.

FIG. 3 shows the case in which the wireless USB device (2-1) executes remote activation processing for the wireless USB host 1 in a sleep state.

Here, the wireless USB host 1 is configured to transition to the sleep state during a period in which it does not have to operate, in order to suppress the operating power. In the sleep state, the wireless USB host 1 transmits a beacon 32 in the number 2 slot assigned to it. The beacon 32 transmitted by the wireless USB host 1 includes a header, a beacon parameters DRP_IE and DCR, and the like.

In the header, the kind of the packet and the sequence number are written. As the beacon parameter, identification information such as MAC address information about the wireless USB host 1, the beacon slot number indicating the beacon slot in which the wireless USB host 1 transmits the beacon, and the like are written. DRP_IE is reservation information for reserving a media access slot. FCS (Frame Check Sequence) is information for performing error detection.

The wireless USB host 1 receives beacons transmitted by the wireless USB devices (2-1) to (2-n) and analyzes the con-tents. If an information element for remote activation notification 34 does not exist in the received beacons as a result of the analysis, the wireless USB host 1 continues the sleep state.

When the wireless USB device (2-1) wants to cause the wireless USB host 1 to transition from the sleep state to a normal operation state, it transmits a beacon 33 in which the information element for remote activation notification 34 is included, in the time slot number 3 slot within the beacon period 22. After that, during the beacon period 22, the normal operation state is kept to receive beacons transmitted by the other wireless USB devices (2-2) to (2-n).

After the end of the beacon period 22, the wireless USB device (2-1) transitions to the sleep state, which is a power-saving state, to be in the sleep state during the remaining time of the superframe.

The wireless USB host 1 which has received the beacon 33 analyzes the contents included in the received beacon 33. If the information element for remote activation notification 34 exists in the contents, the wireless USB host 1 starts remote activation processing and returns from the sleep state to the normal operation state.

According to the wireless communication system configured as described above, it is not necessary to reserve a media access slot for transmitting a remote activation device notification in advance, by transmitting the remote activation device notification within a beacon period. Thereby, it is possible to transmit the remote activation device notification to the wireless USB host irrespective of reservation by the other wireless USB devices (2-2) to (2-n).

Furthermore, in transmitting the remote activation device notification, since the wireless USB devices (2-2) to (2-n) do not have to receive the control information (MMC)-transmitted from the wireless USB host 1, they can transition to the sleep state in a superframe except the beacon period (BP) 22. Therefore, it is possible to reduce power consumption of the wireless USB devices (2-2) to (2-n).

It is apparent that the present invention is not limited to the above embodiment, but may be modified and changed without departing from the scope and spirit of the invention.

What is claimed is:

1. A wireless communication system comprising:
a host; and
a device which performs wireless communication with said host; wherein
said device transmits a remote activation notification requesting activation of said host during a beacon period for sending out a beacon which includes reservation information for reserving a time slot for performing data transfer; and
when receiving said remote activation notification from the device during said beacon period, said host switches an operation state from a sleep state to an active state.

2. The wireless communication system according to claim 1, wherein said remote activation notification is an information element included in said beacon.

3. The wireless communication system according to claim 1, wherein, when transmitting said remote activation notification requesting activation of said host during said beacon period, said device switches said operation state from an active state to a sleep state.

4. The wireless communication system according to claim 1, wherein said wireless communication system is a wireless USB system.

5. A device which performs wireless communication with a host, wherein said device transmits a remote activation notification requesting activation of said host during a beacon period for sending out a beacon which includes reservation information for reserving a time slot for performing data transfer.

6. A host which performs wireless communication with a device, wherein, when receiving a remote activation notification requesting activation of said host during a beacon period for sending out a beacon which includes reservation information for reserving a time slot for performing data transfer, said host switches an operation state from a sleep state to an active state.

7. A wireless communication method wherein a remote activation notification requesting activation of a host is transmitted during a beacon period for sending out a beacon which includes reservation information for reserving a time slot for performing data transfer.

8. The wireless communication method according to claim 7, wherein said remote activation notification is an information element included in said beacon.

9. The wireless communication method according to claim 7, wherein said wireless communication method is a wireless USB communication method.
